(19) United States
(12) Patent Application Publication
(10) Pub. No.: US 2008/0088260 A1
(43) Pub. Date: Apr. 17, 2008

(54) Backlight system

(75) Inventors: Yu-Ju Hsu, Miao-Li (TW); Ko-Wei Chien, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/974,786

(22) Filed: Oct. 16, 2007

(30) Foreign Application Priority Data
Oct. 16, 2006 (TW) 95138077

(51) Int. Cl. H05B 41/36; F21V 8/00; G02F 1/13357

(52) U.S. Cl. 315/294; 349/65; 362/612

(57) ABSTRACT

An exemplary backlight system (200) has a light guide plate (240) having a light incident surface(244); and a light source module (220) disposed at one side of the light incident surface. The light source module has a plurality of light emitting diodes (LEDs), a part of LEDs are working light sources and the other part of LEDs are spare light sources which work when the working light sources stops working.

### FIELD OF THE INVENTION

The present invention relates to a backlight system and a liquid crystal display having the same, and particularly to a backlight system and a liquid crystal display having a working light source and a spare light source.

### GENERAL BACKGROUND

Liquid crystal displays are commonly used as display devices for compact electronic apparatuses, because they not only provide good quality images but are also very thin. Because liquid crystal in a liquid crystal display does not emit any light itself, the liquid crystal requires a light source to display texts or images.

Referring to FIG. 7 and FIG. 8, a typical backlight system 100 includes a light guide plate 110, a light source 120 and a driver 130. The light guide plate 110 includes a light incident surface 114 adjacent to the light source 120, a light emitting surface 112 perpendicularly adjoining the light incident surface 114. The light source 120 has six light emitting diodes (LEDs) 121 connected in series, which are encapsulated by transparent resins into a bar-shaped LED module. Light beams from the LEDs 121 are directly introduced to the light guide plate 110 through the light incident surface 114. However, any one of the six LEDs 121 is damaged, the whole light source 120 can not work normally.

For resolving above-described question, parallel connection resolution is provided, as shown in FIG. 9 and FIG. 10. The six LEDs are divided to three branch circuits, which are a first branch circuit 122, a second branch circuit 124, and a third branch circuit 126. Each branch circuit 122, 124, 126 has two adjacent LEDs connected in series. The three branch circuits 122, 124, 126 are connected in parallel. An alternated resolution is shown in FIG. 11 and FIG. 12, each three alternated LEDs are connected in series to form a branch circuit. Thus, the six LEDs are divided to two branch circuits 123, 125, the two branch circuits 123, 125 being connected in parallel.

However, in above described two resolutions, any one LED is damaged, the corresponding branch circuit can not work normally. And, the light guide plate 110 corresponding the damaged branch circuit has a dark region, which causes an uneven light beams emitting over the whole of the light emitting surface 112.

What is needed, is an improved backlight system that can overcome the above-described deficiencies.

### SUMMARY

In one preferred embodiment, an exemplary backlight system has a light guide plate having a light incident surface; and a light source module disposed at one side of the light incident surface. The light source module has a plurality of light emitting diodes (LEDs), a part of LEDs are working light sources and the other part of LEDs are spare light sources which work when the working light sources stops working.

In another preferred embodiment, an exemplary liquid crystal display has a liquid crystal panel and a backlight system providing light beams to the liquid crystal panel. The backlight system has a light guide plate having a light incident surface; and a light source module disposed at one side of the light incident surface. The light source module has a plurality of light emitting diodes (LEDs), a part of LEDs are working light sources and the other part of LEDs are spare light sources which work when the working light sources stops working.

Other novel features, advantages and aspects will become more apparent from the following detailed description when taken in conjunction with the accompanying drawings.

### BRIEF DESCRIPTION OF THE DRAWINGS

The components in the drawings are not necessarily drawn to scale. The emphasis is, instead, placed upon clearly illustrating the principles of different embodiments of the present invention. In the drawings, like reference numerals designate corresponding parts throughout various views, and all the views are schematic.

FIG. 1 is an exploded, isometric view of a backlight system according to a first embodiment of the present invention, which has a light source.

FIG. 2 is a schematic circuit diagram of the light source of FIG. 1.

FIG. 3 is a schematic equivalent circuit diagram of a backlight driving circuit of the light source of FIG. 1.

FIG. 4 is a schematic circuit diagram of an alternate light source of FIG. 1.

FIG. 5 is a schematic circuit diagram of an another alternate light source of FIG. 1.

FIG. 6 is a schematic equivalent circuit diagram of an alternate backlight driving circuit of the light source of FIG. 1.

FIG. 7 is a plane view of a typical backlight system.

FIG. 8 to FIG. 12 show various backlight driving circuits used in the backlight system of FIG. 7. and

FIG. 9 and FIG. 10 respectively show defects produced in the various backlight driving circuits of FIG. 8 to FIG. 12.

### DETAILED DESCRIPTION OF PREFERRED EMBODIMENTS

Reference will now be made to the drawings to describe preferred and exemplary embodiments of the present invention in detail.

Referring to FIG. 1, a liquid crystal display 2 according to a first embodiment of the present invention is shown. The liquid crystal display 2 includes a backlight system 200 and a liquid crystal panel 210. The backlight system 200 provides uniform light beams to the liquid crystal panel 210, which has a light source 220, a diffuser 230, a light guide plate 240 and a reflective film 233.

The light guide plate 240 includes a light incident surface 244, a bottom surface 246 perpendicularly adjoining the light incident surface 244, a light emitting surface 242 opposite to the bottom surface 246. The light guide plate 240 can be made from polycarbonate (PC) or polymethylmethacrylate (PMMA). The light source 220 is disposed adjacent to the light incident surface 244. The diffuser 230 is disposed at the light emitting surface 242, and the reflective film 233 is disposed under the bottom surface 246.

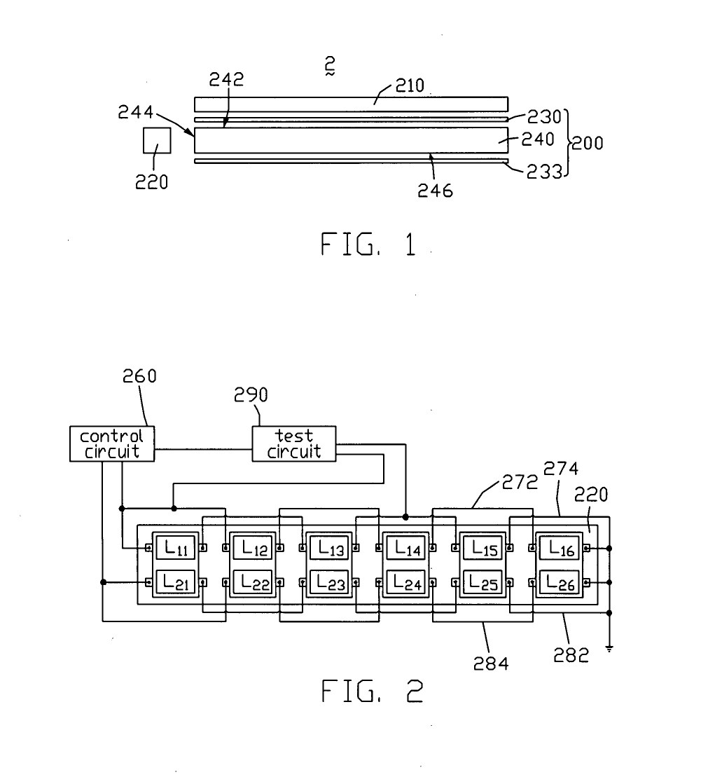

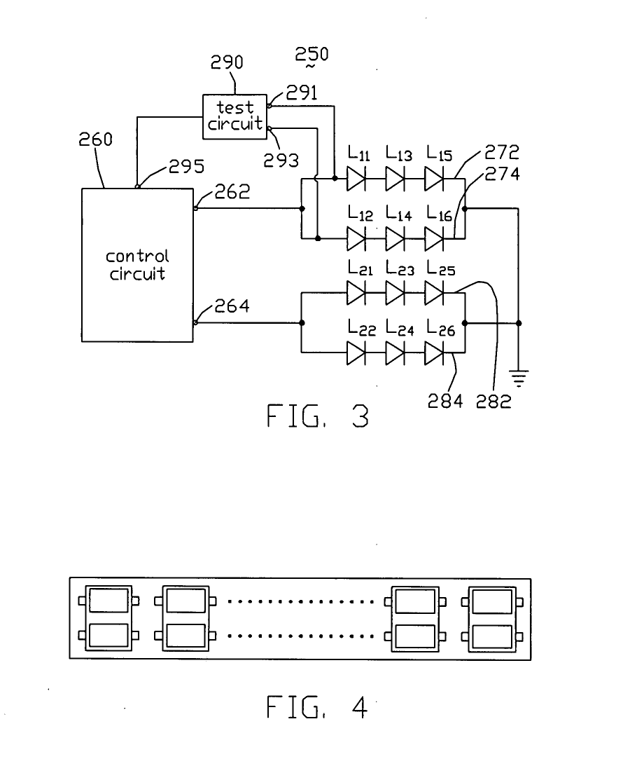

Referring also to FIG. 2 and FIG. 3, the light source 220 is a bar-shaped light emitting diode (LED) module, which has twelve LEDs L11, L12, L13, L14, L15, L16, L21, L22, L23, L24, L25, L26 encapsulated by transparent resins. The twelve LEDs L11, L12, L13, L14, L15, L16, L21, L22, L23, L24, L25, L26 are divided to six LED units connected in sequence. Each LED unit has two LEDs, which are separated by transparent resins, one LED L11, L12, L13, L14, L15, L16 being a working light source, and the other LED L21, L22, L23, L24, L25, L26 being a spare light source. In assembly, each three alternate LEDs form one branch circuit. Thus, the six working light sources are divided into a first branch circuit 272 and a second branch circuit 274, connected in parallel. The first branch circuit 272 has three LEDs L11, L13, and L15 connected in series, and the second branch circuit 274 has three LEDs L12, L14, and L16 connected in series. And the six spare light sources are divided into a third branch circuit 282 and a fourth branch circuit 284, connected in parallel. The third branch circuit 282 has three LEDs L21, L23, and L25 connected in series, and the second branch circuit 284 has three LEDs L22, L24, and L26 connected in series.

The backlight system 200 further has a backlight driving circuit 250, which has a control circuit 260, and a test circuit 290. The control circuit 260 has a first output end 262 connected to ground through the first and the second branch circuits 272, 274, and a second output end 264 connected to ground through the third and the fourth branch circuits 282, 284. The test circuit 290 has a first input end 291 connected to a node between the first output end 262 and the first branch circuit 272, a second input end 293 connected to a node between the second output end 264 and the second branch circuit 274, and an output end 295 connected to the control circuit 260.

In operation, the control circuit 260 provides a working voltage to the first output end 262. The first and the second branch circuits 272, 274 work normally. When any one LED of the first and the second branch circuits 272, 274 is damaged, the first or the second branch circuit 272, 274 is in a break off state. The test circuit 290 detects the working current of the first or the second branch circuit 272, 274 being zero and sends a control signal to the control circuit 260. Then, the control circuit 260 stops the power supply to the first output end 262, and provides the power supply to the second output end 264, and starts the third and the fourth branch circuits 282, 284.

Comparing to the typical technical, when any one LED of the first and the second branch circuits 272, 274 is damaged, the third and the fourth branched circuits 282, 284 starts up. That is, when the working light source is damaged, the backlight system 200 can start up spare light sources.

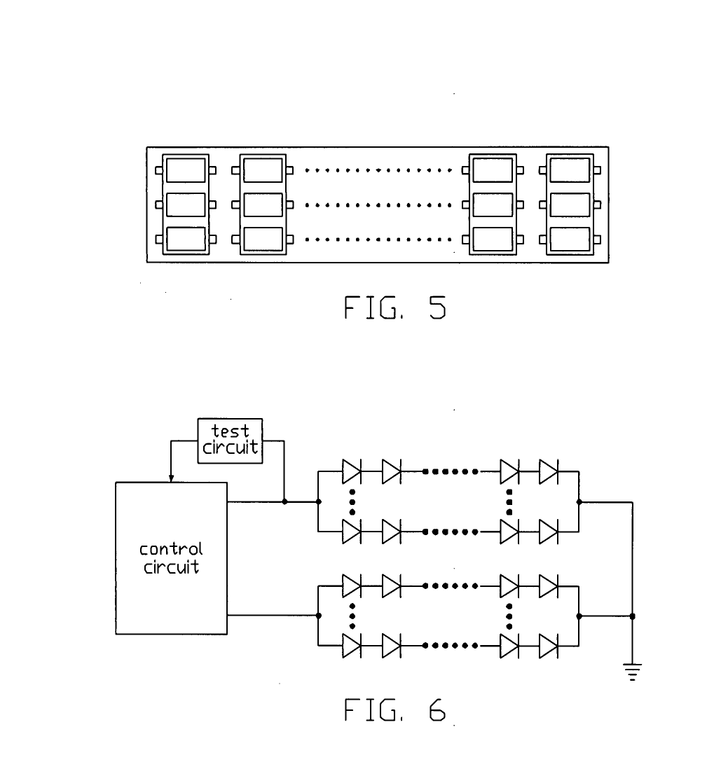

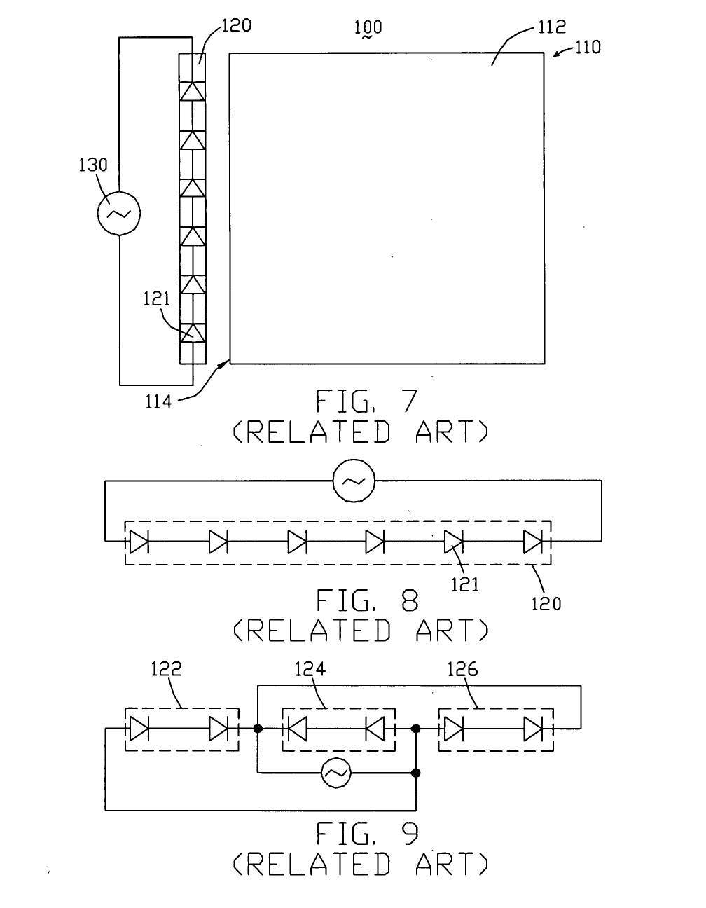

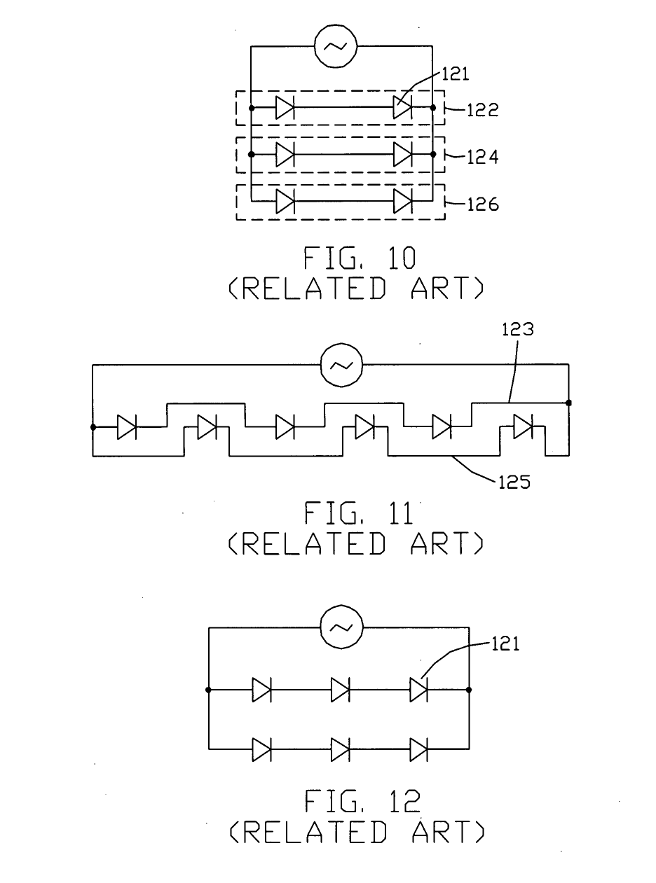

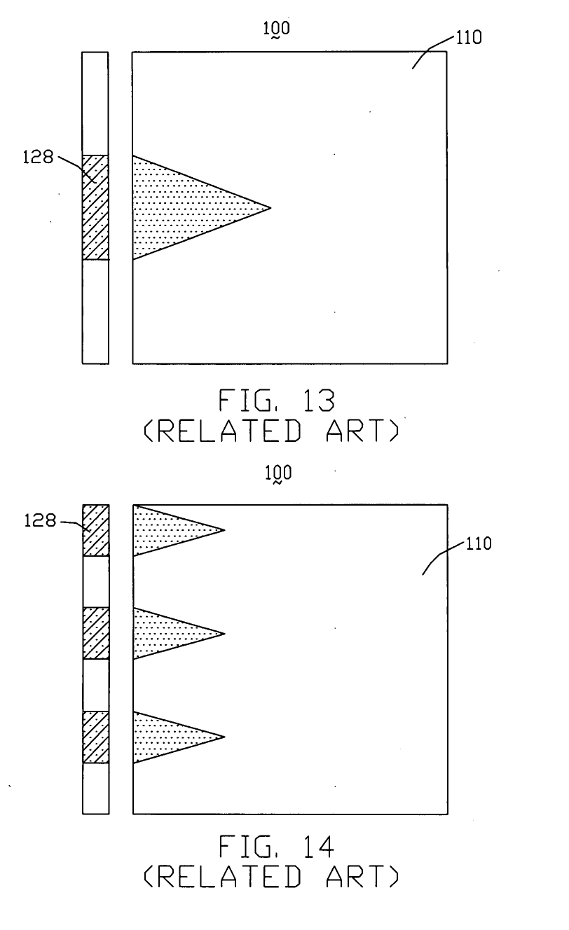

Further or alternative embodiments may include the followings. In one example, the light source can be twenty-four LEDs or six LEDs according to the design needs. Each two LEDs are encapsulated to one LED unit (as shown in FIG. 4). In another example, each three LEDs are encapsulated to one LED unit (as shown in FIG. 5). In addition, the LEDs of an LED unit can be encapsulated by a transparent resin having a yellow fluorescent powder.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight system comprising:
a light guide plate having a light incident surface; and
a light source module disposed at one side of the light incident surface;
wherein the light source module comprises a plurality of light emitting diodes (LEDs), a part of LEDs are working light sources and the other part of LEDs are spare light sources which work when the working light sources stops working.

2. The backlight system as claimed in claim 1, wherein each at least two LEDs are encapsulated to an LED unit, which comprises at least one working light source and at least one spare light source.

3. The backlight system as claimed in claim 2, wherein each LED unit has three LEDs, one being a working light source

4. The backlight system as claimed in claim 1, wherein the light source has twelve LEDs, which are divided to six LED units, each LED unit having a working light source and a spare light source.

5. The backlight system as claimed in claim 1, further comprising a control circuit, which has a plurality of output ends, respectively connecting to the working light source and the spare light source.

6. The backlight system as claimed in claim 1, wherein the working light sources forms at least two branch circuits connected in parallel, each branch circuit comprising at least two LEDs.

7. The backlight system as claimed in claim 6, wherein one output end is connected to ground through the at least two working light sources branch circuits.

8. The backlight system as claimed in claim 6, further comprising a test circuit, when the test circuit detects abnormal working state of the working light source, the test circuit sends a control signal to the control circuit and the control circuit starts up the spare light sources.

9. The backlight system as claimed in claim 6, wherein the spare light sources forms at least two branch circuits connected in parallel, each branch circuit comprising at least two LEDs.

10. The backlight system as claimed in claim 9, wherein one output end is connected to ground through the at least two spare light sources branch circuits.

11. A liquid crystal display comprising:
a liquid crystal panel; and
a backlight system providing light beams to the liquid crystal panel, which comprising:
a light guide plate having a light incident surface; and
a light source module disposed at one side of the light incident surface;
wherein the light source module comprises a plurality of light emitting diodes (LEDs), a part of LEDs are working light sources and the other part of LEDs are spare light sources which work when the working light sources stops working.

12. The liquid crystal display as claimed in claim 11, wherein each at least two LEDs are encapsulated to an LED unit, which comprises at least one working light source and at least one spare light source.

13. The liquid crystal display as claimed in claim 12, wherein each LED unit has three LEDs, one being a working light source

14. The liquid crystal display as claimed in claim 11, wherein the light source has twelve LEDs, which are divided to six LED units, each LED unit having a working light source and a spare light source.

15. The liquid crystal display as claimed in claim 11, further comprising a control circuit, which has a plurality of output ends, respectively connecting to the working light source and the spare light source.

16. The liquid crystal display as claimed in claim 11, wherein the working light sources forms at least two branch circuits connected in parallel, each branch circuit comprising at least two LEDs.

17. The liquid crystal display as claimed in claim 16, wherein one output end is connected to ground through the at least two working light sources branch circuits.

18. The liquid crystal display as claimed in claim 16, further comprising a test circuit, when the test circuit detects abnormal working state of the working light source, the test circuit sends a control signal to the control circuit and the control circuit starts up the spare light sources.

19. The liquid crystal display as claimed in claim 16, wherein the spare light sources forms at least two branch circuits connected in parallel, each branch circuit comprising at least two LEDs.

20. The liquid crystal display as claimed in claim 19, wherein one output end is connected to ground through the at least two spare light sources branch circuits.
